(19) United States
(12) Patent Application Publication
(10) Pub. No.: US 2026/0296280 A1
(43) Pub. Date: Oct. 1, 2026

(54) TRANSPORTATION SEAT

(71) Applicants: NHK SPRING CO., LTD., Yokohama-shi (JP); TOYOTA JIDOSHA KABUSHIKI KAISHA, Toyota-shi (JP); Autoliv Development AB, Vargarda (SE)

(72) Inventors: Kenzo YASUDA, Yokohama-shi (JP); Daisuke TANAKA, Yokohama-shi (JP); Kouichi YAMADA, Yokohama-shi (JP); Kousuke YONEMOCHI, Yokohama-shi (JP); Akira KANEKO, Toyota-shi (JP); Risa NAKAJIMA, Toyota-shi (JP); Shingo FUJIMOTO, Yokohama-shi (JP)

(21) Appl. No.: 19/576,718

(22) Filed: Mar. 24, 2026

(30) Foreign Application Priority Data
Mar. 27, 2025 (JP) 2025-054396

(51) Int. Cl. B60N 2/68; B60N 2/20

(52) U.S. Cl. CPC B60N 2/688; B60N 2/20

(57) ABSTRACT

In a transportation seat, a seatbelt is stowed in a retractor. A back frame is provided to a left-right direction central portion of a seatback, and the retractor is provided to the back frame. This thereby enables a small front-rear direction dimension to be achieved for left-right direction end portions of the seatback.

### CROSS-REFERENCE TO RELATED APPLICATION

This application is based on and claims priority under 35 USC 119 from Japanese Patent Application No. 2025-54396 filed on Mar. 27, 2025, the disclosure of which is incorporated by reference herein.

### BACKGROUND

### Technical Field

The present invention relates to a transportation seat in which framework of a seatback is configured by a back frame.

### Related Art

In a vehicle seat described in Japanese Utility Model Application Laid-Open No. H3-3256, a main frame is provided at a left-right direction central portion of a seatback section, and side frames are provided at the two left-right direction end portions of the seatback section.

In such a vehicle seat, the front-rear direction dimension of the left-right direction end portions of the seatback section becomes large when a retractor stowing a seatbelt is provided at the left-right direction end portions of the seatback section.

### SUMMARY

In consideration of the above circumstances, an object of the present invention is to obtain a transportation seat capable of achieving a small front-rear direction dimension at the left-right direction end portion of a seatback.

A transportation seat of a first aspect of the present invention includes a seatback that is configured to support a back of an occupant from a rear side; a back frame that is provided at a left-right direction central portion of the seatback and that configures a framework of the seatback; and a retractor that is provided at the back frame and that stows a seatbelt.

In the transportation seat of the first aspect of the present invention, the seatback supports the back of the occupant from the rear side. Moreover, the back frame configures framework of the seatback. Furthermore, the seatbelt is stowed in the retractor.

The retractor is provided at the back frame at the left-right direction central portion of the seatback. This accordingly enables a small front-rear direction dimension to be achieved for the left-right direction end portion of the seatback.

A transportation seat of a second aspect of the present invention is the transportation seat of the first aspect of the present invention, wherein the retractor is provided inside the back frame.

In the transportation seat of the second aspect of the present invention, the retractor is provided inside the back frame. This thereby enables a front-rear direction dimension of the left-right direction central portion of the seatback to be suppressed from becoming large.

A transportation seat of a third aspect of the present invention is the transportation seat of the first aspect or the second aspect of the present invention, wherein an insertion portion, through which to insert the seatbelt, is provided at an upper side of a left-right direction end portion of the seatback.

In the transportation seat of the third aspect of the present invention, the insertion portion is provided at the upper side of a left-right direction end portion of the seatback, and the seatbelt is inserted through the insertion portion. The seatbelt can accordingly be guided.

A transportation seat of a fourth aspect of the present invention is the transportation seat of any one of the first aspect to the third aspect of the present invention, further comprising: a seat cushion that is configured to support the occupant from a lower side; and a coupling portion that couples the seat cushion and the back frame together, and that is moved relative to the seat cushion or the back frame such that the seatback is tilted.

In the transportation seat of the fourth aspect of the present invention, the seat cushion supports the occupant from the lower side.

The coupling portion couples the seat cushion and the back frame together, and is moved relative to the seat cushion or the back frame such that the seatback is tilted. This thereby enables the seatback to be tilted even in cases in which the back frame is provided at a left-right direction central portion of the seatback.

### BRIEF DESCRIPTION OF THE DRAWINGS

Exemplary embodiments of the present invention will be described in detail based on the following figures, wherein:

FIG. 1A is a perspective view illustrating a transportation seat according to an exemplary embodiment of the present invention as viewed at an angle from the left-front;

FIG. 1B is a perspective view illustrating a seatback of a transportation seat as viewed at an angle from the left-rear;

FIG. 2 is an exploded perspective view illustrating a transportation seat as viewed at an angle from the left-front;

FIG. 3 is a side view illustrating a transportation seat as viewed from the left;

FIG. 4A is a perspective view illustrating a transportation seat as viewed at an angle from the left-rear;

FIG. 4B is a perspective view illustrating a retractor box of a transportation seat as viewed at an angle from the left-rear; and

FIG. 5 is a cross-section illustrating a seatback as viewed from above.

### DETAILED DESCRIPTION

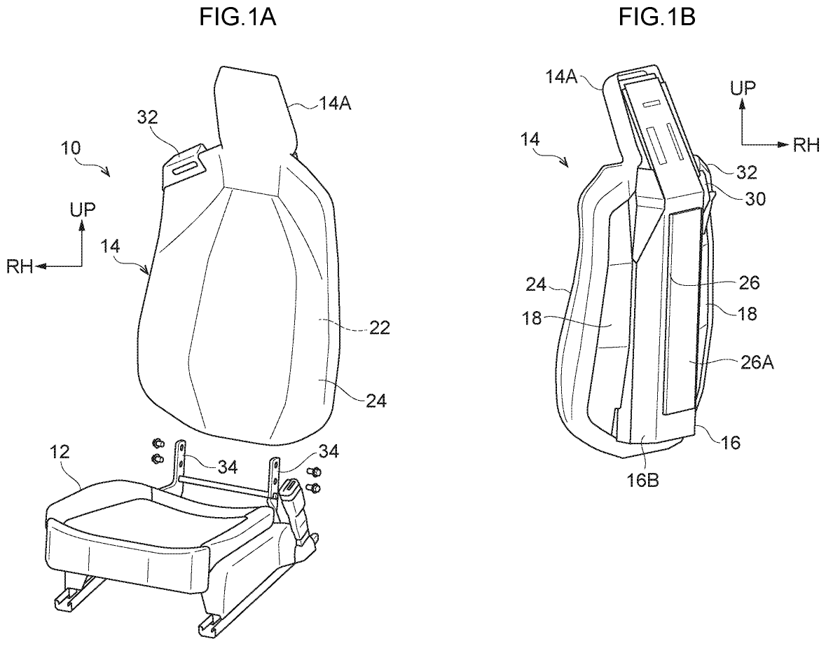

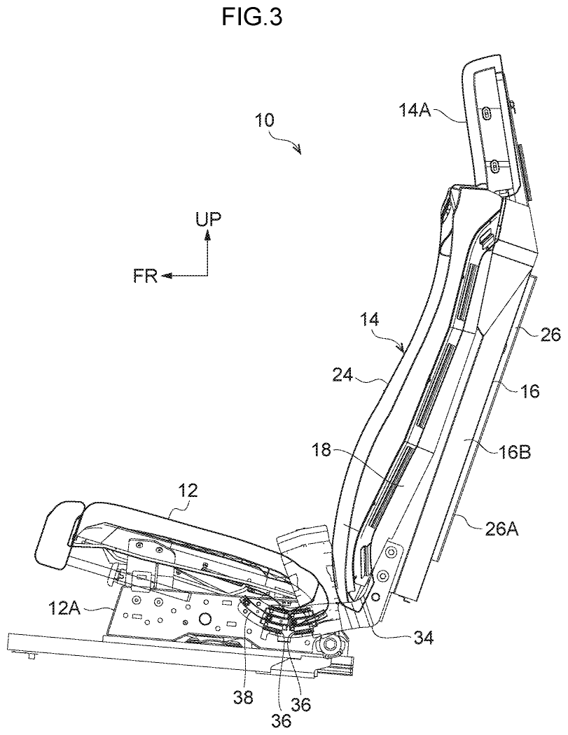

FIG. 1A is an exploded perspective view illustrating a transportation seat 10 according to an exemplary embodiment of the present invention as viewed at an angle from the left-front, and FIG. 3 illustrates the transportation seat 10 in side view as viewed from the left. Note that in the drawings an arrow FR indicates forward of the transportation seat 10, an arrow RH indicates rightward of the transportation seat 10, and an arrow UP indicates upward of the transportation seat 10.

The transportation seat 10 according to the present exemplary embodiment is provided in a vehicle cabin of a vehicle (automobile), and an occupant of the vehicle sits on the transportation seat 10.

As illustrated in FIG. 1A and FIG. 3, a seat cushion 12 is provided at lower section of the transportation seat 10, with the seat cushion 12 supporting the occupant from below. A seatback 14 is provide at an upper side of the rear end portion of the seat cushion 12, with the seatback 14 supporting the back of the occupant from the rear side. A headrest 14A is integrally provided to an upper side of a left-right direction central portion of the seatback 14, with the headrest 14A supporting the head of the occupant from the rear side.

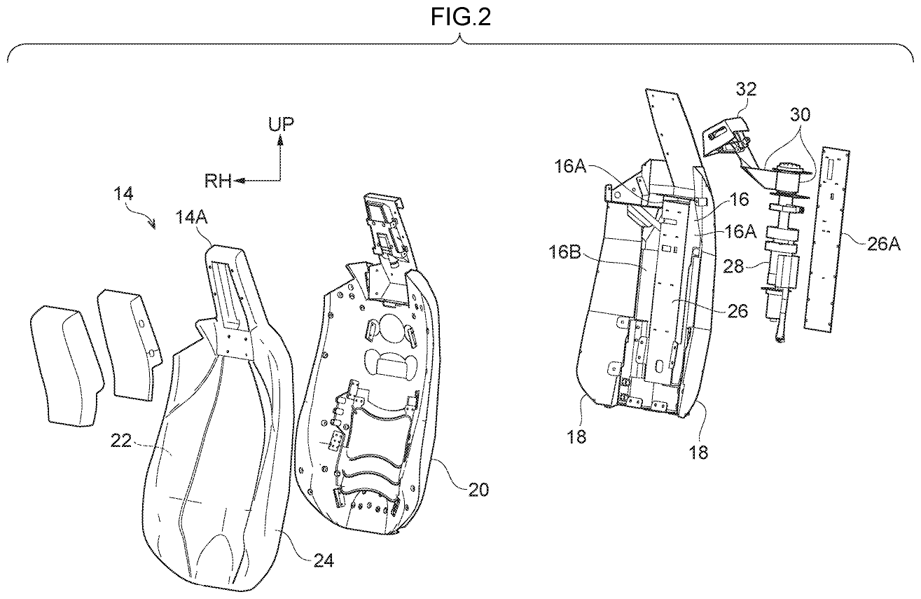

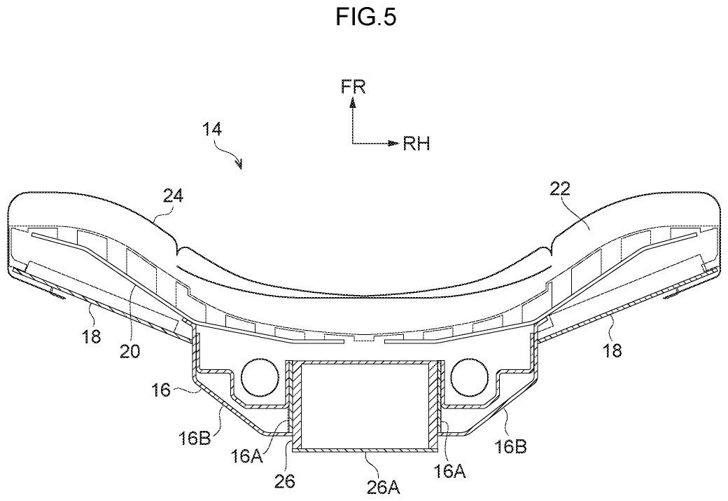

A substantially plate shaped back frame 16 made from metal (see FIG. 2 and FIG. 5) is provided at a rear end portion of a left-right direction central portion of the seatback 14, with the back frame 16 extending along the height direction and configuring framework of the seatback 14. Plate shaped main frames 16A are provided as a pair to a left-right direction central portion of the back frame 16, with the pair of main frames 16A arranged perpendicularly to the left-right direction and separated from each other in the left-right direction. Cover frames 16B are integrally provided to the left side and right side of rear end portions of the pair of main frames 16A, with the inner end portions (main frame 16A side end portions) of the cover frames 16B arranged perpendicularly to the front-rear direction. The outer end portions (end portions on the opposite side to the main frame 16A) of the cover frames 16B are arranged perpendicularly to the left-right direction, with intermediate portions (portions between the inner end portions and the outer end portions) of each of the cover frames 16B arranged along directions oriented toward the front side on progression toward the seatback 14 left-right direction outside.

Plate shaped outer panels 18 made from metal are integrally connected to the left side and the right side of the back frame 16, with the outer panels 18 arranged along directions oriented toward the front side on progression toward the seatback 14 left-right direction outside.

A plate shaped inner panel 20 made from metal is provided at a front side of the back frame 16 and the outer panel 18, with a left portion and a right portion of the inner panel 20 arranged oriented in directions toward the front side on progression toward the seatback 14 left-right direction outside.

A seat pad 22 is arranged at a front side of the inner panel 20, with the seat pad 22 configured by a foam body, such as a foam-molded poly-urethane foam or the like. A covering member 24 covers from a front side of the seat pad 22 to a rear side of the outer panel 18, with the covering member 24 configured from, for example, a cloth material, a covering, or a synthetic leather.

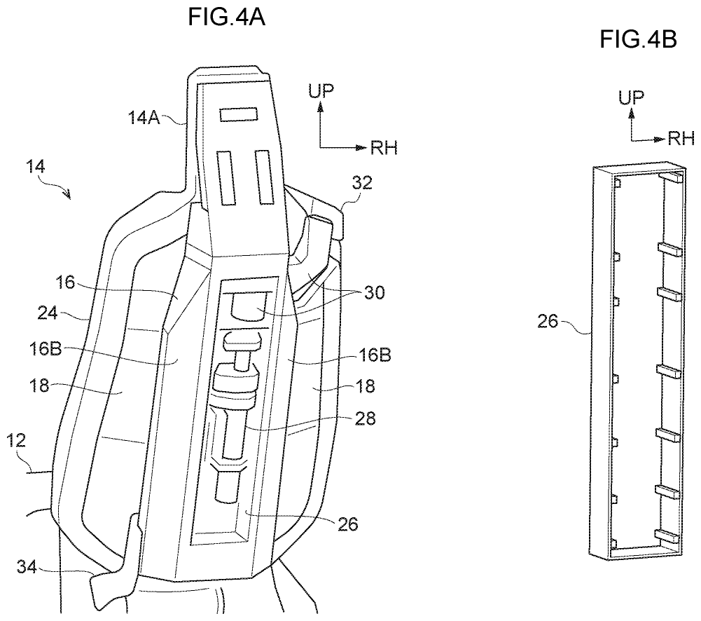

A cuboidal box shaped retractor box 26 made from metal (see FIG. 2, FIG. 4A, FIG. 4B, and FIG. 5) is fitted between the main frames 16A of the back frame 16 and fixed thereto, with the inside of the retractor box 26 opening toward the rear side. A rectangular plate shaped lid 26A made from metal (see FIG. 1B, FIG. 2, and FIG. 5) is fixed to a rear side of the retractor box 26, with the lid 26A closing off a rear side of the inside of the retractor box 26.

A pillar shaped retractor 28 (see FIG. 2 and FIG. 4A) is inserted into and fixed inside the retractor box 26, with a belt shaped seatbelt 30 taken up onto an upper end portion of the retractor 28 and stowed therein. The seatbelt 30 is pulled out from the upper end portion of the retractor 28, with the seatbelt 30 passing through the retractor box 26 and the back frame 16 and extending to a rear side of the seatback 14.

An insertion portion 32 is fixed to an upper side of a right portion (vehicle width direction outside portion) of the seatback 14, with the seatbelt 30 being passed from the rear side through the insertion portion 32 and extending toward the front side of the insertion portion 32.

Upper side portions of respective substantially L-plate shaped brackets 34 (see FIG. 1A and FIG. 3) are fixed to lower end portions at respective outer end portions of the cover frames 16B of the back frame 16, with a pair of sliders 36 serving as moving members fixed to lower side portions of the plate brackets 34. Elongated plate shaped guides 38 serving as coupling portions are respectively fixed to a left portion and a right portion of a cushion frame 12A (framework member) of the seat cushion 12, with the guides 38 extending along the front-rear direction curved in the front-rear direction so as to be convex in shape on the lower side thereof. The pair of sliders 36 are retained by the guides 38 so as to able to slide (move), and seatback 14 is thereby coupled to the seat cushion 12 through the plate brackets 34, the sliders 36, and the guides 38, with the seatback 14 being supported by the seat cushion 12. The sliding of the sliders 36 with respect to the guides 38 is locked, or locking of the sliding of the sliders 36 with respect to the guides 38 is released and the sliders 36 are slid with respect to the guide 38 so as to tilt the seatback 14.

Next, description follows regarding operation of the present exemplary embodiment.

In the transportation seat 10 configured as described above, the back frame 16 is provided to the left-right direction central portion of the seatback 14, and the retractor 28 is provided to the back frame 16. This means that the back frame 16 is not disposed at the two left-right direction end portions of the seatback 14, thereby enabling a small front-rear direction dimension to be achieved for the two left-right direction end portions of the seatback 14. This thereby enables clearance to be easily secured between the two left-right direction end portions of the seatback 14 and the knees of an occupant seated on a seat at the rear side of the seatback 14.

Furthermore, the outer panels 18 at the left side and the right side of the back frame 16 are arranged in directions oriented toward the front side on progression toward the seatback 14 left-right direction outside. This thereby enables clearance to be even more easily secured between the two left-right direction end portions of the seatback 14 and the knees of an occupant seated on a seat at the rear side of the seatback 14.

Moreover, the retractor 28 is provided inside the back frame 16. This thereby enables the front-rear direction dimension of the left-right direction central portion of the seatback 14 to be suppressed from becoming large.

Furthermore, the insertion portion 32 is fixed to the upper side of the right portion of the seatback 14, with the seatbelt 30 inserted through the insertion portion 32. The seatbelt 30 can accordingly be guided by the insertion portion 32.

Moreover, the seatback 14 is coupled to the seat cushion 12 through the brackets 34, the sliders 36, and the guides 38, and the seatback 14 is tilted by the sliders 36 being slid with respect to the guides 38. This thereby enables the seatback 14 to be tilted even in cases in which the back frame 16 is provided to the left-right direction central portion of the seatback 14. There is accordingly no need to provide a seatback 14 tilting mechanism at the left-right direction end portions of the seatback 14, enabling a small front-rear direction dimension to be achieved for the left-right direction end portions of the seatback 14.

Note that in the present exemplary embodiment a case has been described in which the present invention is applied to a vehicle seat. However, the present invention is applicable to a transportation seat other than in a vehicle (for example, in an airplane or a boat).

What is claimed is:

1. A transportation seat, comprising:
a seatback that is configured to support a back of an occupant from a rear side;
a back frame that is provided at a left-right direction central portion of the seatback and that configures a framework of the seatback; and
a retractor that is provided at the back frame and that stows a seatbelt.

2. The transportation seat of claim 1, wherein the retractor is provided inside the back frame.

3. The transportation seat of claim 1, wherein an insertion portion, through which to insert the seatbelt, is provided at an upper side of a left-right direction end portion of the seatback.

4. The transportation seat of claim 1, further comprising:
a seat cushion that is configured to support the occupant from a lower side; and
a coupling portion that couples the seat cushion and the back frame together, and that is moved relative to the seat cushion or the back frame such that the seatback is tilted.

5. The transportation seat of claim 1, wherein:
a left portion and a right portion of a rear face of the seatback are arranged in directions toward a front side on progression toward a left-right direction outside of the seatback.

6. The transportation seat of claim 1, further comprising a retractor box that is provided at the back frame and that houses the retractor.

7. The transportation seat of claim 6, further comprising a lid that opens and closes an interior of the retractor box.

8. The transportation seat of claim 1, wherein the seatbelt is passed through the back frame.
